(19) United States
(12) Patent Application Publication
(10) Pub. No.: US 2006/0263166 A1
(43) Pub. Date: Nov. 23, 2006

(54) Devices and methods for monitoring fastener tension

(75) Inventor: Michael B. Kelly, Safety Harbor, FL (US)

Correspondence Address: Matthew Luxton;Honeywell International Inc., Law Dept. AB2, 101 Columbia Rd., Morristown, NJ, 07962, US

(73) Assignee: Honeywell International Inc.

(21) Appl. No.: 11/131,613

(22) Filed: May 18, 2005

(51) Int. Cl. F16B 31/02

(52) U.S. Cl. 411/14

(57) ABSTRACT

A tension indicating fastener comprising a bolt having a first length when in an unloaded condition, the bolt comprising a head having a top surface, an elongated portion having a first end adjacent to a bottom surface of the head and a second end spaced from the first end, and a bore extending through the bolt from the top surface of the head to the second end of the elongated portion, and a rod having a first end, an opposite second end, and a rod length that is longer than the first length of the bolt, wherein the rod is positioned within the bore so that the second end of the rod is fixed within the bore. The first end of the rod is moveable relative to the top surface of the head when the bolt is elongated under tension, until the rod is in a desired position relative to the top surface as determined by visual or tactile detecting procedures.

### TECHNICAL FIELD

The present invention relates to devices and methods for monitoring the tension of a fastener. More particularly, the present invention relates to bolts and other threaded fasteners that can be monitored when under tension to indicate the tensile condition of the threaded fastener.

### BACKGROUND OF THE INVENTION

Fasteners such as bolts are used for a wide variety of applications in which it is important to measure the amount of force that the fastener is exerting on various surfaces. For example, bolts are often used to secure two or more rigid members together, which is often desirably accomplished by applying and maintaining a particular predetermined load that keeps the members in a certain relationship relative to each other. Thus, various devices have been developed that can be used to measure the load force on a fastener, which vary in their complexity and accuracy. For example, relatively complex and expensive bolt load analyzers that are connected to computers can provide such information, which can be inconvenient because the analyzer and bolt must be in the same physical location. For another example, a torque wrench can be used to tighten a bolt to a specific number of foot pounds of torque, which can vary in accuracy depending on the operator who is using the wrench. In either case, the fastener should be periodically monitored to be sure that the desired amount of force remains on the fastener and that the fastener has not loosened over time. This monitoring activity typically requires the use of a separate tool to measure the force on the fastener, which can be inconvenient and/or difficult to accomplish, depending on the availability of such tools and the skill of the operator.

In addition, some of the known devices for applying and monitoring the correct bolt tension have multiple components with size relationships that must be tightly controlled in order for the device to function properly. It is therefore desirable to provide a device and method for monitoring the tension on a fastener that does not require the use of special equipment and that does not require precise machining of components. In addition, such a device and method desirably allow for easy detection of a condition in which a bolt has become loosened without the use of special equipment.

### SUMMARY OF THE INVENTION

The present invention relates to devices and methods for monitoring the tension in a bolt or other threaded fastener as it is being loaded. In particular, bolts or fasteners of the invention include a longitudinal bore and a rod extending through the bore that can be used to indicate the tensile condition of the bolt. The rod is positioned in a bore extending through the bolt so that one end of the rod is attached to the bolt inside the bore and an opposite end of the rod extends out of the cavity past the head of the bolt. When the bolt is loaded in tension, the end of the rod moves relative to the head so that it retracts into the head of the bolt in such a way that it can be used to indicate the tensile condition or loading of the bolt. The movement of the rod can be observed and monitored using visual and/or tactile methods until a particular location of the end of the rod relative to the top surface of the head of the fastener is reached. This condition may be periodically or continually monitored to track and control any movement of the fastener once it has been loaded under tension.

The invention also relates to methods of using the fasteners described above to monitor and control the retraction of the rod in a direction from above the bolt or fastener head and into the internal bore of the fastener until it reaches a desired position relative to the head of the fastener. The detection methods can be visual and/or tactile and can be performed with only the observation skills of the person tightening the fastener. That is, the methods do not necessarily involve the use of additional measuring or monitoring equipment.

The present invention also relates to methods and devices for manufacturing the particular fastener assemblies described above. These methods and devices use a device for cutting the free end of the rod that extends from the top of the fastener after the opposite end of the rod is secured within the fastener. The device is designed to cut the rod at a precise length relative to the top of the fastener so that only a predetermined portion of the rod extends beyond the top of the fastener. The distance that the rod extends corresponds to the amount the fastener has been determined to lengthen under a certain amount of tension.

In one aspect of this invention, a tension indicating fastener is provided comprising a bolt having a first length when in an unloaded condition and a rod. The bolt comprises a head having a top surface, an elongated portion having a first end adjacent to a bottom surface of the head and a second end spaced from the first end, and a bore extending through the bolt from the top surface of the head to the second end of the elongated portion. The rod has a first end, an opposite second end, and a rod length that is longer than the first length of the bolt, wherein the rod is positioned within the bore so that the second end of the rod is fixed within the bore. The first end of the rod preferably extends above the top surface of the head of the bolt when the bolt is in its unloaded condition. The bolt has a second length when in a loaded condition, wherein the second length of the bolt is greater than the first length and generally equal to the rod length. When the bolt is in its loaded condition, the first end of the rod is preferably flush with the top surface of the head. The loaded condition of the bolt is discernible by tactile detection and/or visual inspection. In order to secure the rod within the bore, the bore can have a threaded portion adjacent the second end of the elongated portion and the rod can have a corresponding threaded portion at its second end, so that the threaded portion of the second end of the rod is engageable with the threaded portion of the bore. Alternatively or additionally, the second end of the rod can be fixed within the bore with an adhesive.

In another aspect of the invention a method of loading a tension indicating fastener to a predetermined tension is provided, the method comprising the steps of providing a bolt having a first length when in an unloaded condition, the bolt comprising a head having a top surface, an elongated portion having a first end adjacent to a bottom surface of the head and a second end spaced from the first end, and a bore extending through the bolt from the top surface of the head to the second end of the elongated portion, then securing a rod within the bore of the bolt. The rod has a first end, an opposite second end, and a rod length that is longer than the first length of the bolt, wherein the rod is positioned within the bore so that the second end of the rod is fixed within the bore and the first end of the rod extends above the top surface of the head. The method further includes applying an increasing tensile force on the bolt to increase the length of the bolt while simultaneously monitoring a retraction of the rod into the bore of the bolt until the bolt is elongated to a second length, wherein the second length of the bolt is equal to the rod length. The step of monitoring of the retraction of the rod while applying increasing force on the bolt may include a tactile and/or visual determination of the position of the first end of the rod relative to the top surface of the head.

### BRIEF DESCRIPTION OF THE DRAWINGS

The present invention will be further explained with reference to the appended Figures, wherein like structure is referred to by like numerals throughout the several views, and wherein:

FIG. 1 is a cross-sectional side view of one exemplary embodiment of a bolt of the invention, including a bore that extends through the length of the bolt along its longitudinal centerline;

FIG. 2 is a cross-sectional side view of the bolt of FIG. 1 with a tension-monitoring rod positioned within the bore, showing the bolt in an unloaded condition;

FIG. 3 is a cross-sectional side view of the bolt of FIG. 2, showing the bolt under tension with the rod retracted relative to the top of the bolt;

FIG. 4 is a cross-sectional side view of a top portion of a bolt of the type shown in FIGS. 1 through 3, further including a device used in the manufacturing of the bolt and rod assembly for cutting the rod to a predetermined length; and

FIG. 5 is a cross-sectional side view of a top portion of a bolt of the invention, further including a recessed portion in the bolt head.

### DETAILED DESCRIPTION OF THE PREFERRED EMBODIMENTS

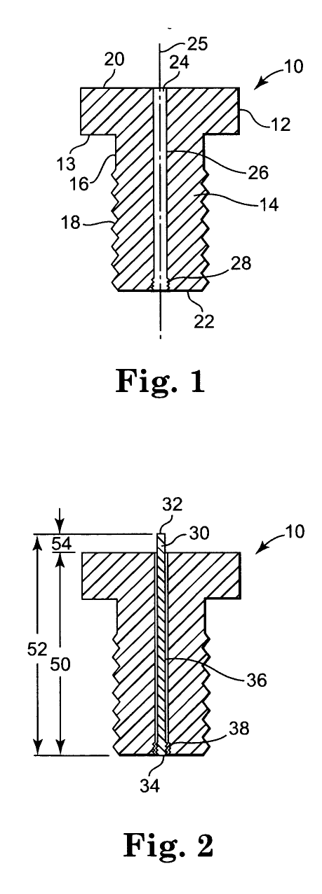

Referring now to the Figures, wherein the components are labeled with like numerals throughout the several Figures, and initially to FIG. 1, one preferred configuration of a fastener or bolt 10 is illustrated, which generally includes a head 12 and an elongated portion 14. Head 12 may be provided in a number of configurations, such as circular, hexagonal, and the like, where the choice of configuration corresponds with the tool that will be used to turn the fastener 10 for engagement with threads. For example, head 12 may have multiple flat surfaces around its periphery (e.g., a square or hexagonal shape) for engagement with a wrench that will be used for tightening bolt 10. In addition, while head 12 is illustrated as being rectangular in cross section, head 12 may instead be shaped as a semi-circle, partial ellipse, or the like and/or may include notches, chamfered edges, or other extensions or recessed portions. In any case, a bottom surface 13 of head 12 is preferably designed or chosen to provide the maximum amount of surface contact between bottom surface 13 and the surface with which it will come in contact. For example, a flat surface 13 will preferably be used when bolt 10 will be positioned in material having a flat or planar surface surrounding the bolt hole. Head 12 may further include a textured or knurled surface to provide a surface with additional gripping capabilities for tightening of bolt 10.

Elongated portion 14 is illustrated in this figure as including an unthreaded portion 16 adjacent to head 12 and a threaded portion 18 at its opposite end. However, the entire length of the elongated portion 14 may be threaded or the relationship between the amounts of elongated portion 14 that are threaded and unthreaded can be different than that shown and will be chosen depending on the particular end use for the bolt. Flanges or other extensions may be provided between head 12 and elongated portion 14, which can be designed to mate with corresponding flanges or other contours in the surface that receives the bolt.

Bolt 10 includes a top surface 20 that coincides with the top surface of head 12 and a bottom surface 22 that coincides with the bottom surface of elongated portion 14. A bore 24 extends from top surface 20 to bottom surface 22 through the length of bolt 10 along a longitudinal axis 25 that extends generally through the center of bolt 10. Bore 24 includes an unthreaded portion 26 and a threaded portion 28, where unthreaded portion 26 extends a particular distance from top surface 20 toward bottom surface 22 and threaded portion 28 generally extends from the end of unthreaded portion 26 down to the bottom surface 22.

Referring additionally to FIG. 2, bolt 10 is illustrated with an elongated rod 30 positioned within bore 24. This figure illustrates the bolt 10 in its unloaded condition (i.e., bolt 10 is not under tension or compression), where bolt 10 has a length 50 and rod 30 has a length 52 that is longer than length 50. Rod 30 includes a first end 32, an opposite second end 34, an unthreaded portion 36 adjacent first end 32, and a threaded portion 38 adjacent second end 34. Rod 30 is preferably provided with a diameter that is slightly smaller than the diameter of bore 24 to provide a relatively secure fit between rod 30 and bore 24 when rod 30 is positioned in bolt 10. As shown, threaded portion 38 of rod 30 is a significantly smaller percentage of the overall length of rod 30 than unthreaded portion 36 to enable free movement of the rod 30 relative to the elongated portion 14 within bore 24, as will be explained below. Threaded portion 38 includes threads that correspond with the threads of threaded portion 28 of bore 24 for securing rod 30 within bore 24. Preferably, the length of threaded portion 28 of bore 24 is the same or similar to the length of threaded portion 38 of rod 30; however, it is possible that the lengths of the threaded portions 28, 38 are relatively different from each other. In any case, it is preferable that threaded portion 28 of bore 24 is long enough to securely engage with the threads of threaded portion 38 of rod 30 to keep the rod 30 from loosening within bore 24.

To assemble rod 30 within bolt 10 to provide a fastener for monitoring tension in accordance with the invention, rod 30 is inserted into bore 24 through bottom surface 22 of bolt 10 until threaded portion 38 of rod 30 engages with threaded portion 28 of bore 24. At this point, rod 30 will need to be rotated to thread rod 30 into bore 24, which requires that the rod 30 is able to be grasped or otherwise mechanically manipulated. For one example, the rod 30 can be long enough that a substantial length of rod 30 extends past the top surface 20 after it is inserted into bore 24, even before the threaded portion 38 is engaged with threaded portion 28. In this way, the portion of rod 30 that extends beyond the top surface 20 of bolt 10 can be manually or mechanically grasped and turned to screw the rod 30 into bore 24. In another example, one or both ends 32, 34 of rod 30 can include a notch or other surface that can be engageable with a tool that can rotate rod 30 and thereby screw rod 30 into bore 24.

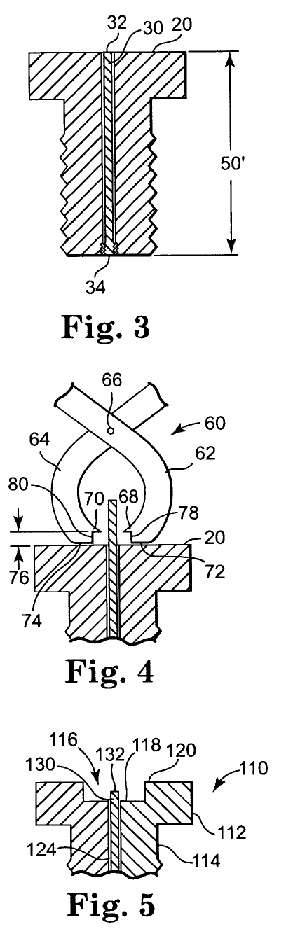

As shown in FIG. 2, when bolt 10 is in an unloaded condition, its length 50 is slightly less than length 52 of rod 30 so that first end 32 of rod 30 extends at least slightly above top surface 20 of bolt 10. In addition, second end 34 of rod 30 is preferably flush with bottom surface 22 of bolt 10 when the threaded portion 38 of rod 30 is fully engaged with threaded portion 28 of bore 24. In this configuration, the bolt 10 with inserted rod 30 can be used for its intended purpose such as securing materials to one another. In accordance with the invention, the difference between the length 50 of bolt 10 and the length 52 of rod 30 is a precalculated or predetermined length 54 that corresponds generally with the amount that bolt 10 will be stretched or extended when it is loaded with tension necessary to hold the two or more external parts together. As shown in FIG. 3, bolt 10 is under sufficient tension that it is extended to a length 50′ that corresponds with the length 50 of the bolt in its unloaded condition plus the predetermined length 54. In a preferred embodiment where the second end 34 of rod 30 is flush with the bottom surface 22 of the bolt 10, the length 50′ will be equal to the length 52 of the rod 30.

To use the bolt assembly of the present invention, a bolt 10 is provided in its unloaded condition with a rod 30 extending above top surface 20 by a distance 54, as illustrated in FIG. 2. In an exemplary assembly, two pieces of material are provided having particular requirements that must be met for securing them to each other using one or more bolts. For example, a particular assembly may require a specific amount of pressure at one or more bolt locations to adequately hold the two pieces of material together. This amount of pressure required is used to calculate the distance that a particular bolt will extend or lengthen if subjected to this amount of pressure. This precalculated distance is then used to manufacture, assemble, and/or select a bolt and rod assembly of the invention that has a rod extending beyond the top surface of the bolt by this same distance.

One or more pieces of material can be provided with bolt holes having threads that correspond to the thread pattern of threaded portion 18 of elongated portion 14. The bolt assembly can then be inserted into the hole in the materials and finger tightened, which would not typically be enough force to lengthen the bolt 10 and thereby change the distance by which the rod 30 extends above the top surface 20 of the bolt. However, it is possible that this finger tightening may provide a slight lengthening or extension of the bolt 10 if the force applied is particularly strong and/or if the material from which the bolt 10 is made is relatively easy to lengthen. Notably, because the rod 30 is only secured to bolt 10 adjacent its second end 34, the remainder of the rod 30 from the threaded portion 38 to the first end 32 is free to move relative to the interior surface of the bore 24.

In any case, the bolt can then be tightened using the assistance of manual or automatic tool or devices until the bolt starts to measurably lengthen due to the tension applied along its length. The amount of torque applied to the bolt through the bolt head does not need to be measured. Rather, the bolt continues to be tightened until it lengthens enough that one end of the rod is flush with the top of the head of the bolt. This determination can be made in a tactile manner in which the operator simply runs his or her finger periodically across the top surface of the head of the bolt until the rod is in its proper position. That is, the operator can use a tactile approach in which a rod that extends above the top head surface will be detectable by a human finger and/or a rod that is retracted below the top head surface will result in the operator detecting the edges of the bore rather than the end of the rod. Alternatively or additionally, the operator can visually determine whether the rod is extending above the top of the bolt and continue to tighten the bolt until the rod is no longer visible above the top surface of the bolt. Alternatively or additionally, an automatic or semiautomatic tightening device may have an apparatus to detect the point where the rod is flush with the surface thereby causing tightening process to be stopped. At this point, the proper amount of tension has been applied to the bolt and further adjustments and measurements will often be unnecessary.

The tension on the bolt can continue to be monitored after installation, however, by examining the position of the rod relative to the top surface of the bolt. That is, if the rod is retracted or recessed beneath the top surface of the bolt, then the bolt may have become further elongated in such a way that the desired tension is no longer being provided by this bolt. In other words, external conditions or other forces may have somehow increased the pressure being applied by the rod such that it has lengthened too much. The bolt can then be replaced or loosened, if desired, so that the end of the rod again becomes flush with the top surface of the bolt. On the other hand, if the rod protrudes above the top surface of the bolt after an inspection of the bolt, the bolt could potentially have loosened or an underlying gasket or other material has become compressed in such a way that the bolt is no longer providing enough tension. Under these circumstances, the unit may be disassembled to determine the source of the lessened tension. Alternatively, if some amount of stretching over time is expected, the bolt can then be tightened until it has lengthened enough that the rod is again flush with the top surface of the bolt, for example. Due to the advantages provided by the present invention, no additional measuring equipment or tools are necessary to periodically monitor whether such tightening or loosening of the bolt has taken place. Rather, a simple visual or tactile inspection of the bolt will provide the necessary information regarding the tension on a particular bolt.

Many variables can factor into the calculations of a bolt and rod assembly of the present invention. For example, the materials from which the bolt and rod components are manufactured can react differently in different types of environments. With the materials involved in the present invention, it is particularly important to understand the characteristics of the bolt and rod material in different physical environments so that the elongation and other behaviors of that material in the typical environment in which the bolt will be installed can be used in any calculations. For example, the typical temperature of the environment where the bolt will be used may be a factor in choosing a material from which the bolt should be made. In addition, several features of the bolt, including its length, diameter, thread pattern, and the like can effect the ability of the bolt to achieve and maintain a certain tension initially and after an extended period of time. Thus, it is desirable to select a material and component design that provides repeatable behavior of the bold and rod assemblies, and consistent application of pressure for a certain period of time.

In order to manufacture a bolt and rod assembly having a particular length 54 of rod 30 extending above top surface 20, as shown in FIG. 2, rod 30 may be provided in a number of ways. In one embodiment, rod 30 is manufactured to a specific length 52 that is exactly the length of rod that is needed to both engage with the threads of bore 24 at threaded portion 38 and extend by a predetermined length 54 above the top surface 20 when rod 30 is secured within bore 24. Depending on the degree of accuracy that will be required when monitoring the tension provided by a particular bolt, the length 54 may need to be carefully measured and adjusted during assembly by further threading rod 30 within bore 24 or by backing the rod 30 out of 15 bore 24 until the correct length 54 is achieved. This process may be facilitated by incorporating a relatively stiff, yet somewhat malleable material into threaded portion 38 of rod 30 and/or threaded portion 28 of bore 24. This material will prevent or minimize movement of rod 32 within the bore 24.

In another embodiment, rod 30 is manufactured to have a length that initially is longer the final desired length 52, which includes the desired length 54 that the rod extends above the top surface 20 of head 12. The rod 30, which is inserted into the bore 24, is then cut or otherwise shortened so that only a portion of rod 30 having a length 54 extends above top surface 20. One particular method and device that can be used for measuring and cutting a portion of rod 30 to a particular length is illustrated in FIG. 4, although it is understood that a number of different devices can also be used for cutting rod 30, when desired. Preferably, such devices will be easy for an operator to use without requiring difficult adjustments or complicated techniques.

FIG. 4 illustrates a portion of a device 60 that can be used to cut the rod 30 to a certain desired length when the rod is positioned within the bore of a bolt, such as bore 24 of bolt 10. Device 60 is discussed in the following description relative to the bolt and rod assemblies shown in FIGS. 2 and 3, however, device 60 may be used with other embodiments of the invention and/or other types of devices that are differently configured but which include a portion of a rod that extends above the head of a bolt. With particular application to bolt 10 described above, device 60 is designed to accurately cut rod 30 at a distance from top surface 20 of bolt 10 that corresponds with length 54. Device 60 includes a first arm 62 that is connected to a second arm 64 at a hinge point 66 about which the arms 62, 64 can rotate. First arm 62 includes a first cutting edge 68 at its distal end, and second arm 64 includes a second cutting edge 70 at its distal end. Proximal ends of first and second arms 62, 64 are not shown, but can comprise any configuration that can cause cutting edges 68, 70 to rotate toward each other, including configurations that are actuated manually and/or mechanically. The first cutting edge 68 is spaced at a distance 76 from a contact surface 72 of first arm 62 and the second cutting edge 70 is also spaced at the same distance 76 from a contact surface 74 of second arm 64. This distance 76 corresponds with the desired length 54 that a rod is to extend beyond a top surface of a bolt of the present invention. The distance 76 also corresponds with the height of a distancing guide portion 78 of first arm 62 and the height of a distancing guide portion 80 of second arm 64.

To operate device 60, a bolt is provided with a rod secured therein, as with bolt 10 discussed above. Again, bolt 10 with rod 30 will be discussed relative to the use of device 60, although it is possible that device 60 could be used with alternative embodiments of bolts. With regard to bolt 10, when rod 30 is inserted and threaded within bore 24, the rod 30 will extend above top surface 20 by a distance that is greater than the desired extension amount. The rod 30 can then be cut by placing surface 72 against top surface 20 on one side of rod 30, placing surface 74 against top surface 20 on the other side of rod 30, and then the device 60 is manipulated to bring cutting edges 68, 70 into contact with rod 30. Sufficient force on device 60 will force cutting edges 68, 70 further toward each other to cut through the rod 30, leaving a portion of rod 30 above top surface 20 of bolt 10 that corresponds in length to desired length 54. Thus, device 60 does not require time-consuming or complicated manipulations and adjustments to provide a rod of a certain length 52 that extends above top surface 20 by a length 54. In addition, the use of devices such as device 60 provides a system that allows for a range of possible extension lengths 54 from a single bolt and rod assembly by providing devices having distancing guide portions of different heights. That is, many different devices 60 with varying distances between their cutting edges and contact surfaces can be provided at the location where the bolts are manufactured and/or assembled. The device 60 also minimizes the importance of manufacturing a bolt to an exact length and/or manufacturing a rod to an exact corresponding length for use relative to the present invention because the exact amount of rod extension above the bolt head can be customized with the cutting action of the device.

FIG. 5 illustrates an alternative embodiment of a head 112 for a bolt 110 as described with regard to the present invention. Head 112 includes a top surface 120 and a recessed portion 116 having a recessed surface 118 that is below the top surface 120. Bolt 110 includes an elongated portion 114 extending from a bottom surface of head 112 and a bore 124 that extends through the center of the head 112 and elongated portion 114. Recessed portion 116 generally surrounds the bore 124 and may simply be countersunk to provide protection for any rod that extends above the recessed surface 118 from damage that could occur during handling or shipping, for example. In this case, recessed portion may have a circular shape. To provide an additional or alternative purpose for a recessed area, the recessed portion 116 may have an outer shape that provides for engagement with a tool that can be used to tighten the bolt, although in this case it would be necessary that the tool does not contact any rod that may extend above the recessed surface 118. In addition, such a tool would need to be periodically removed from recessed portion 116 to observe the position of any rod portion that is extending from above the recessed surface 118.

An elongated rod 130 is positioned within bore 124, where the rod 130 has a first end 132 and an opposite second end (not shown) that is fixed within the bore 124 at the end of the bolt opposite top surface 120. This figure illustrates the bolt 110 in its unloaded condition (i.e., bolt 110 is not under tension or compression), where first end 132 of rod 130 protrudes or extends above the recessed surface 118, and optionally can also extend above top surface 120. In any case, the principles and alternatives described above relative to bolt 10 of FIGS. 1-3 generally also apply to the operation of bolt 110 having a rod 130 positioned within its bore 124. That is, placing the bolt 110 under tension will increase the overall length of the bolt 110 at the same time that the first end 132 of rod 130 will move relative to the top surface 120 and the recessed surface 118. In this case, however, the location of the first end 132 of rod 130 relative to the recessed surface 118 is monitored, rather than the location of end 132 relative to the top surface 120 of head 112. Tactile and/or visual inspection of the location of end 132 is performed until the end 132 is flush with the recessed surface 118.

In additional exemplary embodiments of the invention, the rod can be differently attached or secured within the bore of the bolt than the embodiments described above, such as with adhesives or other bonding materials or processes. In these cases, the rod could optionally be provided without a threaded portion and may instead be smooth or include a textured surface or other configuration for promoting a secure attachment of the end of the rod within the bore. The rod can also be differently configured so that it can be inserted into the bore through the top surface of the bolt at the bolt head and secured into threads in the bore. In yet another alternative embodiment, the bore may not extend through the entire length of the bolt, but may instead extend from the top surface of the bolt through its head and only a part of its elongated portion, leaving at least a small portion of the elongated portion solid (i.e., with no bore or channel extending through it). A rod inserted in this channel can be secured at the bottom portion thereof by adhesives or the like. Alternatively, the rod can be secured within the channel or bore of any of the embodiments through the use of a friction fit between the surfaces.

Bolt and rod assemblies of the present invention can alternatively be used in other ways for placing materials in tension than the exemplary assembly method described above. For one example, the bolt and rod assemblies can be used with a nut to fasten two or more pieces of material to each other, where the principles described above relative to lengthening of the bolt are equally applicable to a bolt used with a nut. That is, one end of a rod is attached within a bolt and a free end of the rod is free to move relative to the bolt as the bolt lengthens when the nut is tightened.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A tension indicating fastener comprising:
a bolt having a first length when in an unloaded condition, the bolt comprising a head having a top surface, an elongated portion having a first end adjacent to a bottom surface of the head and a second end spaced from the first end, and a bore extending through the bolt from the top surface of the head to the second end of the elongated portion; and
a rod having a first end, an opposite second end, and a rod length that is longer than the first length of the bolt, wherein the rod is positioned within the bore so that the second end of the rod is fixed within the bore.

2. The fastener of claim 1, wherein the first end of the rod extends above the top surface of the head of the bolt when the bolt is in its unloaded condition.

3. The fastener of claim 2, wherein the bolt has a second length when in a loaded condition, wherein the second length of the bolt is greater than the first length and generally equal to the rod length.

4. The fastener of claim 3, wherein the first end of the rod is flush with the top surface of the head when the bolt is in its loaded condition.

5. The fastener of claim 4, wherein the loaded condition of the bolt is discernible by tactile detection.

6. The fastener of claim 2, wherein the rod is retractable into the bore as the bolt moves from an unloaded condition to a loaded condition in response to an applied tensile force.

7. The fastener of claim 1, wherein the bore has a threaded portion adjacent the second end of the elongated portion.

8. The fastener of claim 7, wherein the rod has a threaded portion at its second end, wherein the threaded portion of the second end of the rod is engageable with the threaded portion of the bore.

9. The fastener of claim 1, wherein the second end of the rod is fixed within the bore with an adhesive.

10. The fastener of claim 1, wherein the second end of the rod is fixed within the bore so that the second end of the rod cannot move with respect to the bore.

11. The fastener of claim 1, wherein the first length of the bolt differs from the rod length by a predetermined extension amount.

12. The fastener of claim 11, wherein the predetermined extension amount corresponds with a desired amount that the bolt will lengthen in response to an applied tensile force.

13. A tension indicating fastener comprising:
a bolt having a first length when in an unloaded condition, the bolt comprising a head having a top surface, an elongated portion having a first end adjacent to a bottom surface of the head and a second end spaced from the first end, and a bore extending through the bolt from the top surface of the head to the second end of the elongated portion; and
a rod having a first end, an opposite second end, and a rod length that is longer than the first length of the bolt, wherein the rod is positioned within the bore so that the second end of the rod is fixed within the bore and the first end of the rod extends above the top surface of the head,
wherein the bolt is extendable to a second length in response to application of a tensile force with a resulting retraction of the first end of the rod toward the top surface of the head, wherein the second length of the bolt is defined by the condition of the fastener in which the first end of the rod is flush with the top surface of the head.

14. The fastener of claim 13, wherein the retraction of the first end of the rod into the bore is capable of being monitored using at least one of a tactile detection process and a visual detection process to determine when the bolt has extended to its second length.

15. The fastener of claim 14, wherein at least one of the tactile and visual detection
processes is executable using at least one of human sensing techniques and mechanical devices.

16. A method of loading a tension indicating fastener to a predetermined tension, comprising the steps of:
providing a bolt having a first length when in an unloaded condition, the bolt comprising a head having a top surface, an elongated portion having a first end adjacent to a bottom surface of the head and a second end spaced from the first end, and a bore extending through the bolt from the top surface of the head to the second end of the elongated portion;
securing a rod within the bore of the bolt, the rod having a first end, an opposite second end, and a rod length that is longer than the first length of the bolt, wherein the rod is positioned within the bore so that the second end of the rod is fixed within the bore and the first end of the rod extends above the top surface of the head;
applying an increasing tensile force on the bolt to increase the length of the bolt while simultaneously monitoring a retraction of the rod into the bore of the bolt until the bolt is elongated to a second length, wherein the second length of the bolt is equal to the rod length.

17. The method of claim 16, wherein the step of monitoring of the retraction of the rod while applying increasing force on the bolt comprises at least one of a tactile determination and a visual determination of the position of the first end of the rod relative to the top surface of the head.

18. The method of claim 17, wherein the determination of the position of the first end of the rod relative to the top surface of the head is executed using at least one of human sensing techniques and mechanical devices.

19. The method of claim 16, wherein the step of securing the rod within the bore of the bolt further comprises engaging threads at the second end of the rod with threads in the portion of the bore adjacent the second end of the elongated portion.

20. The method of claim 16, wherein the step of securing a rod within the bore of the bolt further comprises providing the rod in an uncut length and cutting the rod to the rod length after securing the rod in the bore.
